(19) United States
(12) Patent Application Publication
(10) Pub. No.: US 2025/0224695 A1
(43) Pub. Date: Jul. 10, 2025

(54) DEVELOPING CARTRIDGE

(71) Applicant: Zhuhai Ninestar Information Technology Co. , Ltd, Zhuhai (CN)

(72) Inventors: Tiansheng PENG, Zhuhai (CN); Hao YANG, Zhuhai (CN); Hailong MA, Zhuhai (CN); Wenjie ZHAO, Zhuhai (CN); Xin LV, Zhuhai (CN); Haoli HUANG, Zhuhai (CN)

(21) Appl. No.: 19/095,024

(22) Filed: Mar. 30, 2025

Related U.S. Application Data
(63) Continuation of application No. PCT/CN2023/131142, filed on Nov. 12, 2023.

(30) Foreign Application Priority Data
Nov. 12, 2022 (CN) 202223014626.7
Nov. 19, 2022 (CN) 202223091265.6
Nov. 26, 2022 (CN) 202223169611.8
Dec. 1, 2022 (CN) 202223251029.6
Dec. 13, 2022 (CN) 202223362635.5
Dec. 14, 2022 (CN) 202223378125.7
Jan. 4, 2023 (CN) 202320013462.1
Jan. 17, 2023 (CN) 202320153764.9
Feb. 24, 2023 (CN) 202320317975.1
Mar. 10, 2023 (CN) 202320457910.7

(51) Int. Cl. G03G 21/18; G03G 15/08; G03G 21/16

(52) U.S. Cl. CPC G03G 21/1828; G03G 15/0808; G03G 15/0863; G03G 15/0889; G03G 15/0896; G03G 21/1652; G03G 21/1814; G03G 21/186; G03G 2215/0836; G03G 2221/166

(57) ABSTRACT

A developing cartridge can be detachably installed on a drum cartridge in an image forming apparatus, where a mounting cavity is provided on the drum cartridge and a photosensitive drum and a first groove wall are provided in the mounting cavity. The developing cartridge includes: a casing having a first side and second side arranged oppositely along a first direction, where the casing can be installed in the mounting cavity along a second direction; a developing roller rotatably arranged in the casing, where the rotation axis of the developing roller is parallel to the first direction; and a separator including a force-receiving part, where a first inclined surface is formed on the force-receiving part, and the first inclined surface receives a separation force provided by the image forming apparatus and drives the casing to move in a direction away from the photosensitive drum.

### CROSS-REFERENCE TO RELATED APPLICATIONS

This application is a continuation of International Application No. PCT/CN2023/131142, filed on Nov. 12, 2023, which claims priority of Chinese Patent Application No. 202223014626.7 filed on Nov. 12, 2022, Chinese Patent Application No. 202223091265.6 filed on Nov. 19, 2022, Chinese Patent Application No. 202223169611.8 filed on Nov. 26, 2022, Chinese Patent Application No. 202223251029.6 filed on Dec. 1, 2022, Chinese Patent Application No. 202223362635.5 filed on Dec. 13, 2022, Chinese Patent Application No. 202223378125.7 filed on Dec. 14, 2022, Chinese Patent Application No. 202320013462.1 filed on Jan. 4, 2023, Chinese Patent Application No. 202320153764.9 filed on Jan. 17, 2023, Chinese Patent Application No. 202320317975.1 filed on Feb. 24, 2023, and Chinese Patent Application No. 202320457910.7 filed on Mar. 10, 2023, the entire content of each of which is hereby incorporated by reference.

### TECHNICAL FIELD

The present application relates to the technical field of image forming apparatus, and in particular to a developing cartridge.

### BACKGROUND

An electrophotographic image forming apparatus includes a detachable developing cartridge installed on a drum cartridge of the image forming apparatus. A developing roller on the developing cartridge supplies developer to a photosensitive drum on the drum cartridge, so that an electrostatic latent image is formed on the photosensitive drum.

Long-term contact between the developing roller and the photosensitive drum will damage the developing roller and the photosensitive drum. Therefore, a separator is generally provided on the developing cartridge. The separator is configured to receive the separation force applied by the image forming apparatus. When the developing cartridge is not needed, the developing roller and the photosensitive drum are separated from each other to prevent damage to the developing roller and the photosensitive drum, thereby ensuring the image quality of the image forming apparatus. However, the complex separator structure is not conducive to the miniaturization of the developing cartridge, nor is it conducive to the control of the manufacturing cost of the developing cartridge.

### SUMMARY

The objective of the present disclosure is to provide a developing cartridge with a simple structure and stable operation to solve the technical problems in the existing technologies.

The present disclosure provides a developing cartridge, detachably installed on a drum cartridge in an image forming apparatus, where the drum cartridge is provided with a photosensitive drum, the image forming apparatus includes a separation force output member, and the developing cartridge includes: a casing having a first side and a second side arranged opposite to each other along a first direction, a third side and a fourth side arranged opposite to each other along a second direction, and a fifth side and a sixth side arranged opposite to each other along a third direction, where the casing is installed in the drum cartridge in the second direction, and the first direction, the second direction and the third direction intersect each other; a coupling rotatable about a coupling axis extending in the first direction, the coupling being positioned at the first side; a developing roller rotatable about a developing axis extending in the first direction, the developing roller being positioned at the third side; a storage medium including an electrical contact surface, the electrical contact surface in contact with the image forming apparatus, the electrical contact surface facing the sixth side, and the electrical contact surface being positioned at the second side; and a separator for receiving a separation force applied by the separation force output member that causes the casing to move, the separator including a first inclined surface where the separation force output member moves in the first direction and abuts against the first inclined surface, and the separator being positioned at the first side.

In some embodiments, the separator is fixedly arranged on the casing, an extending direction of the first inclined surface is inclined relative to the first direction, and the first inclined surface causes the casing to move.

In some embodiments, an extension line of a line connecting the coupling axis and the developing axis passes through the first inclined surface.

In some embodiments, a protective cover is provided at the first side, the protective cover protects the coupling, and the separator is integrally formed with the protective cover or fixedly installed on the protective cover.

In some embodiments, a starting end of the first inclined surface is further away from the sixth side than an ending end of the first inclined surface in the third direction, and the starting end of the first inclined surface is closer to the second side than the ending end of the first inclined surface in the first direction.

In some embodiments, the developing cartridge further includes a contact part, where the contact part is positioned at the second side, and the first side swings away from a photoconductor drum with the contact part as a fulcrum.

In some embodiments, the developing cartridge further includes a load-bearing part, where the load-bearing part is positioned at the first side and protrudes in first direction, the load-bearing part contacts the drum cartridge to support the developing cartridge, and the load-bearing part moves in the third direction with respect to the drum cartridge when the first inclined surface cause the first side to move.

In some embodiments, the load-bearing part is semi-cylindrical, the separator is integrally formed with the load-bearing part.

In some embodiments, the separator is further away from the developing roller than the load-bearing part in the second direction.

In some embodiments, the developing cartridge further includes a forced pushing part, where the forced pushing part includes a pressure receiving surface for receiving a forced pushing force applied by the drum cartridge, the pressure receiving surface is flat, and the first inclined surface overcomes the forced pushing force and causes the first side to move.

In some embodiments, a distance from the forced pushing part to the developing roller is greater than a distance from the load-bearing part to the developing roller in the second direction.

In some embodiments, an angle between the first inclined surface and the first direction ranges from 38° to 58°.

In some embodiments, the angle between the first inclined surface and the first direction is 48°.

In some embodiments, the first inclined surface receives the separation force from the first direction and breaks the separation force into the third direction to move the first side in a direction away from the photosensitive drum.

In some embodiments, the developing cartridge further includes a holder, where the holder holds the electrical contact surface, and the holder is fixedly mounted on the second side.

In some embodiments, the separator at least partially overlaps with the holder when viewed in the first direction.

In some embodiments, the developing cartridge further includes an agitator, where the agitator receives a force transmitted by the coupling and rotates, and an axis of rotation of the agitator is located between the separator and the developing axis in the second direction.

In some embodiments, the separator is constrained not to move relative to the casing in the first direction.

Other aspects or embodiments of the present disclosure can be understood by those skilled in the art in light of the description, the claims, and the drawings of the present disclosure.

### BRIEF DESCRIPTION OF THE DRAWINGS

FIG. 1 is a schematic structural diagram of a developing cartridge installed on a drum cartridge of an image forming apparatus according to Embodiment 1;

FIG. 2 is a schematic structural diagram of a drum cartridge on an image forming apparatus according to Embodiment 1;

FIG. 3 is a partial schematic diagram of a drum cartridge according to Embodiment 1;

FIG. 4 is a partial schematic diagram of the drum cartridge from another perspective according to Embodiment 1;

FIG. 5 is a schematic structural diagram of a developing cartridge according to Embodiment 1;

FIG. 6 is another perspective of the developing cartridge according to Embodiment 1;

FIG. 7 is a schematic structural diagram of a developing roller according to Embodiment 1;

FIG. 8 is a side view of a layer thickness regulating blade according to Embodiment 1;

FIG. 9 is an exploded view of a developing cartridge according to Embodiment 1;

FIG. 10 is a schematic structural diagram of a developing cartridge after a developing roller is hidden according to Embodiment 1;

FIG. 11 is a side view of a first side of a hidden cover according to Embodiment 1;

FIG. 12 is an exploded view of a first side of a transmission assembly according to Embodiment 1;

FIG. 13 is a schematic structural diagram of a protective cover according to Embodiment 1;

FIG. 14 is a schematic diagram of the protective cover from another perspective according to Embodiment 1;

FIG. 15 is a schematic structural diagram of a sixth side of a casing according to Embodiment 1;

FIG. 16 is a schematic structural diagram of another perspective of the sixth side of the casing according to Embodiment 1;

FIG. 17 is a side view of a first side of a developing cartridge according to Embodiment 1;

FIG. 18 is a side view of a second side of the developing cartridge according to Embodiment 1;

FIG. 19 is a schematic structural diagram of a holder according to Embodiment 1;

FIG. 20 is a schematic structural diagram of the holder from another perspective according to Embodiment 1;

FIG. 21 is a schematic structural diagram of a first bearing according to Embodiment 1;

FIG. 22 is a schematic structural diagram of a developing cartridge installed on a drum cartridge in an unseparated state according to Embodiment 1;

FIG. 23 is a cross-sectional view of a developing cartridge installed on a drum cartridge in an unseparated state according to Embodiment 1;

FIG. 24 is a schematic structural diagram of a developing cartridge installed on a drum cartridge in a separated state according to Embodiment 1;

FIG. 25 is a cross-sectional view of a developing cartridge installed on a drum cartridge in a separated state according to Embodiment 1;

FIG. 26 is a schematic structural diagram of a developing cartridge according to Embodiment 2;

FIG. 27 is an exploded view of a developing cartridge according to Embodiment 2;

FIG. 28 is an exploded view of a first side of a casing according to Embodiment 2;

FIG. 29 is a cross-sectional view of a casing along a second direction according to Embodiment 2;

FIG. 30 is a side view of a first side of a developing cartridge according to Embodiment 2;

FIG. 31 is a side view of a second side of a developing cartridge according to Embodiment 2;

FIG. 32 is an exploded view of a second side of a casing according to Embodiment 2;

FIG. 33 is a schematic structural diagram of a second side of a casing according to Embodiment 2;

FIG. 34 is a schematic structural diagram of a left end surface of a holder according to Embodiment 2;

FIG. 35 is a schematic structural diagram of a right end surface of a holder according to Embodiment 2;

FIG. 36 is a schematic structural diagram of a right end surface of a first bearing according to Embodiment 2; and

FIG. 37 is a schematic structural diagram of a sixth side of a casing according to Embodiment 2.

### DETAILED DESCRIPTION

The embodiments described below with reference to the accompanying drawings are exemplary and are merely configured to explain the present disclosure, but should not be construed as limiting the present disclosure.

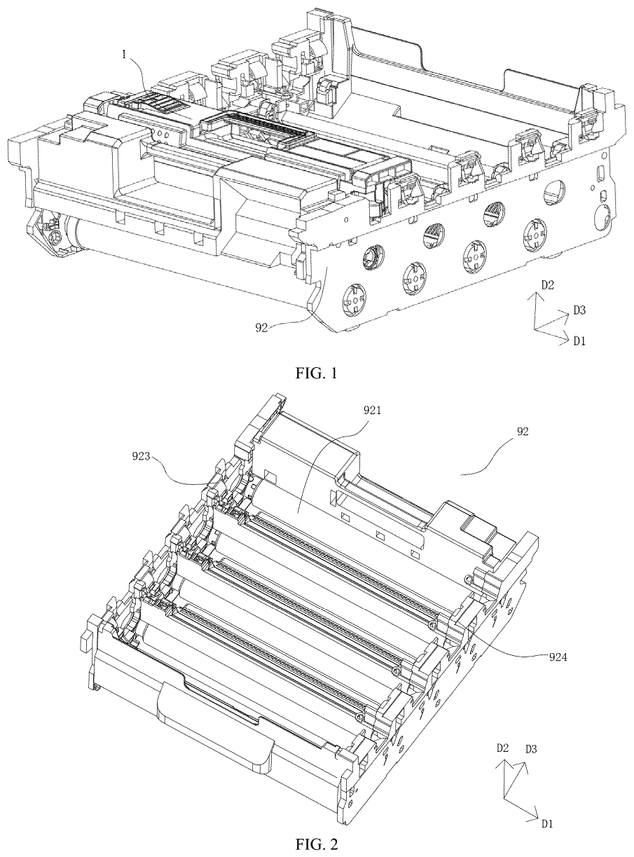

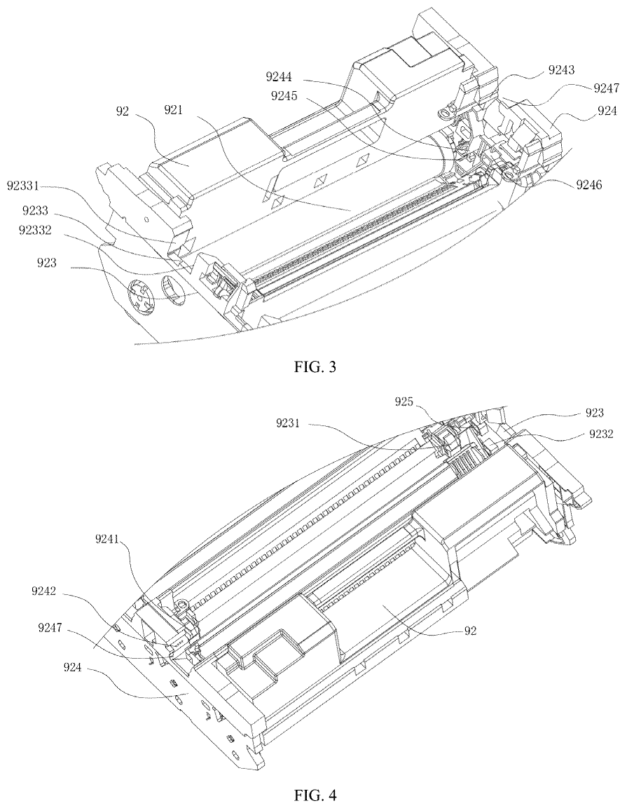

As shown in FIGS. 1 to 8, the present disclosure provides a developing cartridge 1 that can be detachably installed on a drum cartridge 92 in an image forming apparatus.

In order to better illustrate the developing cartridge 1, the concepts of the first direction D1, the second direction D2 and the third direction D3 are introduced. The first direction D1, the second direction D2 and the third direction D3 intersect each other, and are optionally perpendicular to each other. The length direction of the casing 10 is defined as the first direction D1, and has a left end and a right end in the first direction D1. The height direction of the casing 10 is the second direction D2, and has an upper end and a lower end in the second direction D2. The width direction of the casing 10 is the third direction D3, and has a front end and a rear end in the third direction D3.

### Embodiment 1

As illustrated in FIGS. 1 to 5, the image forming apparatus is provided with a separation force output member 91 and a drum cartridge 92. The separation force output member 91 applies a separation force to the developing cartridge 1. The drum cartridge 92 has a first side plate 923 and a second side plate 924 that are relatively arranged in a first direction D1, and a photosensitive drum 921 rotatably supported by the first side plate 923 and the second side plate 924. The rotation axis of the photosensitive drum 921 is parallel to the first direction D1. The photosensitive drum 921 is configured to receive the developer provided by the developing cartridge 1, form an electrostatic latent image, and display the image on an imaging sheet.

A developing cartridge 1 is detachably installed on the drum cartridge 92 of the image forming apparatus. When the developing cartridge 1 is installed on the drum cartridge 92, the first side plate 923 is adjacent to the first side 11 of the developing cartridge 1, and the second side plate 924 is adjacent to the second side 12 of the developing cartridge 1.

A first thrust member 9231 and a second thrust member 9241 are provided on the drum cartridge 92. The first thrust member 9231 is arranged close to the first side plate 923, and the second thrust member 9241 is arranged close to the second side plate 924. The first thrust member 9231 and the second thrust member 9241 are provided with elastic members compressed or stretched along the third direction D3, that is, the first thrust member 9231 and the second thrust member 9241 can move in the third direction D3 relative to the drum cartridge 92.

A second spacer 9247 is provided at the second side plate 924, and an electrical contact 9242 and protrusion 9243 are provided on opposite sides of the second spacer 9247. The electrical contact 9242 can be extended and retracted in the third direction D3. The electrical contact 9242 and the protrusion 9243 are arranged opposite to each other in the third direction D3. The protrusion 9243 extends from top to bottom in the second direction D2 and extends in the direction close to the electrical contact 9242 in the third direction D3. The electrical contact 9242 is configured to contact the storage medium 221 on the developing cartridge 1 so that the image forming apparatus can identify the developing cartridge 1.

A first guide part (not shown) is disposed at the first side plate 923, and a second guide part 9244 is disposed at the second side plate 924. The first guide part and the second guide part 9244 are configured to guide the developing cartridge 1 during the process of mounting the developing cartridge 1 to the image forming apparatus, so that the developing cartridge 1 can be installed smoothly. An electrode 9245 is disposed at the second side plate 924 and is adjacent to the second guide part 9244. The electrode 9245 can bear a certain deformation, and the electrode 9245 is configured to transmit the electric energy output by the image forming apparatus to the developing cartridge 1.

The first platform part 9232 is located at the first side plate 923, and the extension direction of the first platform part 9232 is substantially parallel to the third direction D3. The second platform part 9246 is located at the second side plate 924, and the extension direction of the second platform part 9246 is substantially parallel to the third direction D3. In the second direction D2, the second platform part 9246 is located between the protrusion 9243 and the electrode 9245. The first side plate 923 is provided with a first spacer 9233, and the first spacer 9233 includes a first groove wall 92331 and a second groove wall 92332 that are oppositely arranged in the third direction D3.

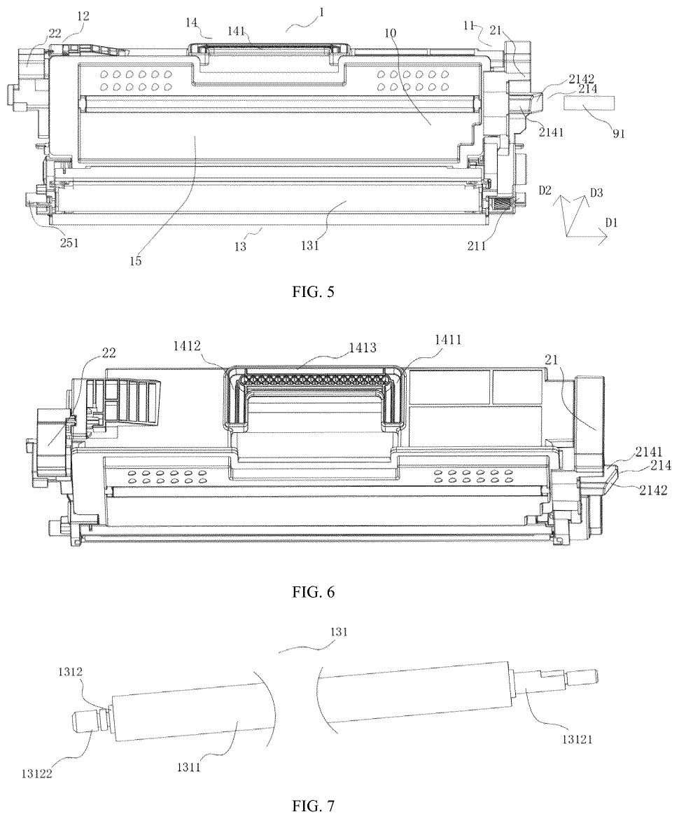

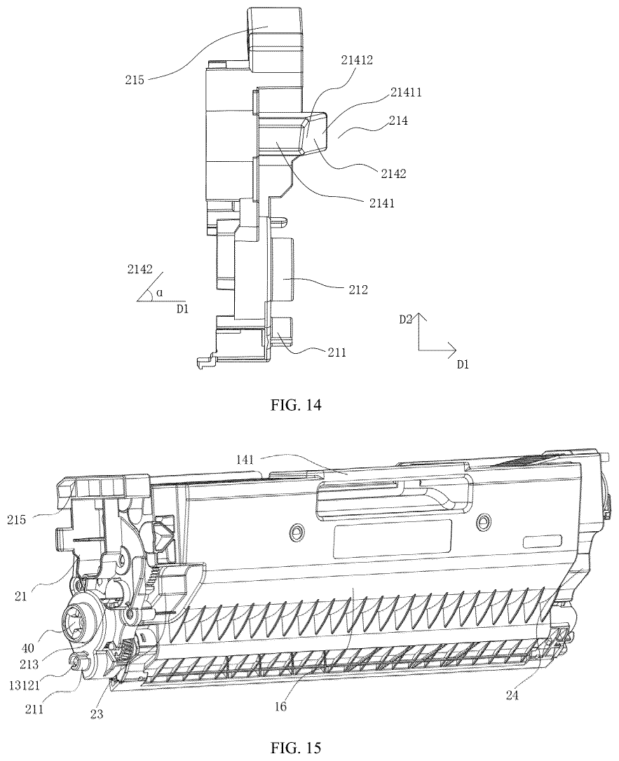

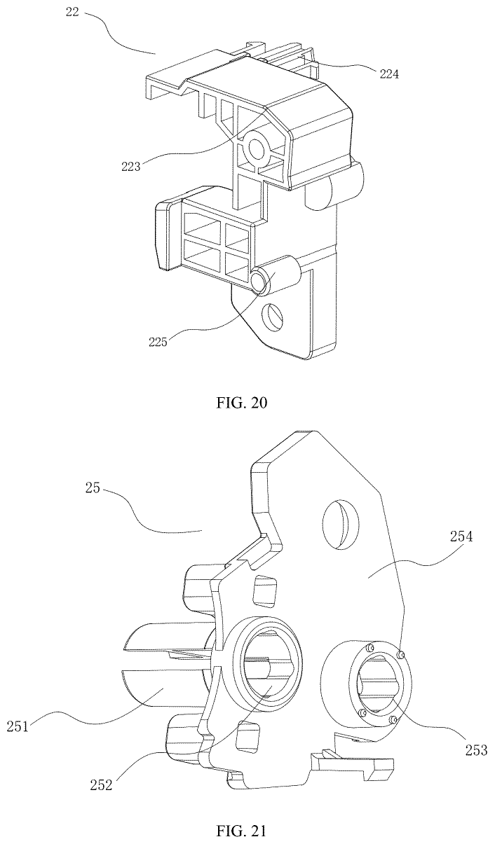

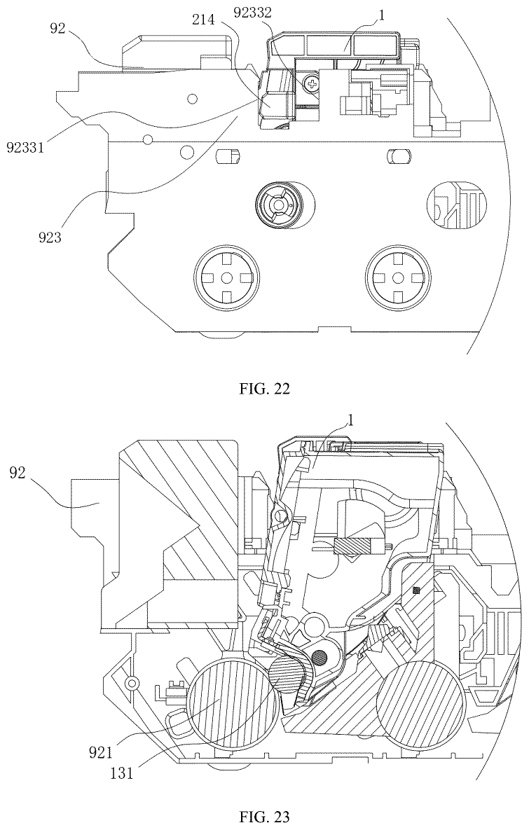

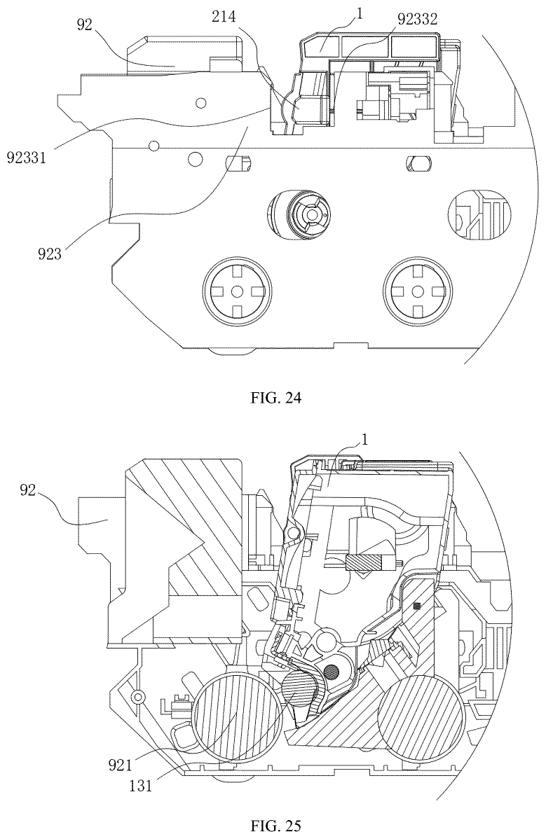

As shown in FIGS. 5-25, the disclosed embodiment provides a developing cartridge 1, which includes a casing 10, a developing assembly, a transmission assembly, an identification assembly and a separator 214.

As shown in FIG. 5, the casing 10 has a receiving cavity for receiving the developer, and the casing 10 has a first side 11 and a second side 12 arranged oppositely in the first direction D1, and a third side 13 and a fourth side 14 arranged oppositely in the second direction D2, and a fifth side 15 and a sixth side 16 arranged oppositely in the third direction D3. The first side 11 and the second side 12 are respectively the right end and the left end of the casing 10 in the first direction D1, the third side 13 and the fourth side 14 are respectively the lower end and the upper end of the casing 10 in the second direction D2, and the fifth side 15 and the sixth side 16 are respectively the front end and the rear end of the casing 10 in the third direction D3. A protective cover 21 is detachably fixedly installed on the first side 11 of the casing 10, and the protective cover 21 at least covers the transmission assembly part, and the protective cover 21 is configured to protect the transmission assembly.

As shown in FIG. 5 and FIG. 6, a handle 141 is provided on the casing 10, and the handle 141 is located at the fourth side 14. A user can pick up the developing cartridge 1 by holding the handle 141. The handle 141 includes a first extension part 1411, a second extension part 1412 and a first connection part 1413. The first extension part 1411 and the second extension part 1412 are both extended along the third direction D3. The first connection part 1413 is connected to the first extension part 1411 and the second extension part 1412 in the first direction D1. The first connection part 1413 is optionally provided with ribs to strengthen the strength of the first connection part 1413, or the ribs may not be provided, or the ribs only extend in the first direction D1, and the length of the ribs in the first direction D1 is the same as the length of the first connection part 1413. In the disclosed implementation, the handle 141 is all made of non-elastic materials and will not be deformed during installation, transportation or use. The handle 141 can be integrally formed with the casing 10, or can be fixedly installed on the casing 10 in a detachable manner.

As shown in FIG. 5 and FIG. 7, the developing assembly includes a developing roller 131, which is located at the third side 13 and is rotatably supported by the first side 11 and the second side 12, and its rotation axis extending in the first direction D1. The developing roller 131 is configured to contact the photosensitive drum 921 and provide developer to the photosensitive drum 921. The developing roller 131 includes a roller body 1311 and a roller shaft 1312. The roller body 1311 is sleeved on the roller shaft 1312 and covers part of the roller shaft 1312. The roller shaft 1312 drives the roller body 1311 to rotate. The roller body 1311 has a rubber component, and the rubber deformation amount of the roller body 1311 is consistent. The roller body 1311 is configured to absorb the developer and transfer the developer to the photosensitive drum 921.

The roller shaft 1312 is rotatably supported by the first side 11 and the second side 12, and the roller shaft 1312 includes a first end 13121 and a second end 13122 in the first direction D1. The first end 13121 is located at the first side 11 and supported by the first side 11, and the first end 13121 is provided with a D-shaped part. The second end 13122 is located at the second side 12, and the first end 13121 and the second end 13122 are not covered by the roller body 1311.

The developing assembly further includes an agitator (not shown in the figures) and a developer feeding roller (not shown in the figure), both of which are rotatably supported by the first side 11 and the second side 12, and the rotation axes of the agitator and the developer feeding roller extending in the first direction D1, and the developer feeding roller is arranged adjacent to the developing roller 131. In the disclosed implementation, there is only one agitator, which is configured to stir the developer in the accommodating chamber, so that the developer generates friction and prevents the developer from agglomerating. In some embodiments, multiple agitators may be provided to better stir the developer.

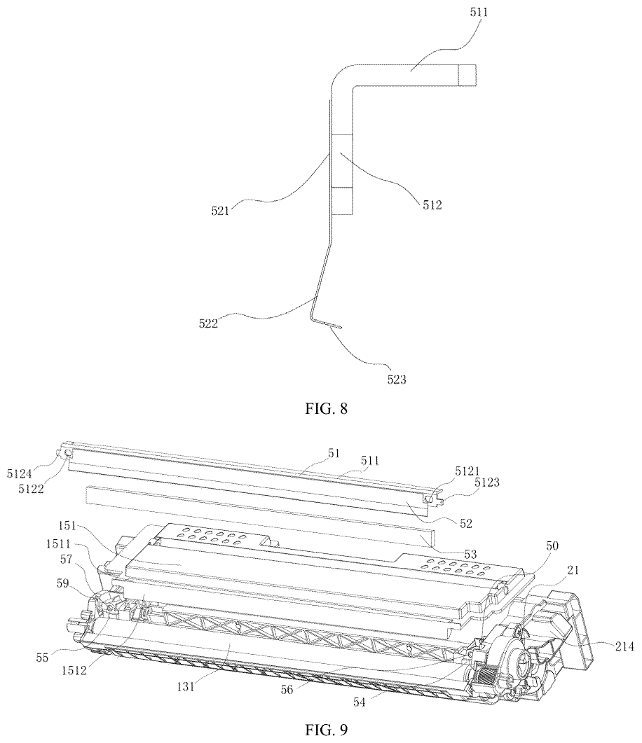

As shown in FIGS. 8 and 9, the developing cartridge 1 includes a layer thickness regulating blade, which is configured to contact the developing roller 131 to control the thickness of the developer layer on the developing roller 131. The layer thickness regulating blade includes a blade frame 51 and a blade 52. The blade frame 51 and the blade 52 both extend along the first direction D1, and the blade 52 is connected to the blade frame 51 by welding or gluing. The blade frame 51 includes a covering part 511 extending approximately in the second direction D2 and a mounting part 512 extending approximately in the third direction D3 on the basis of the covering part 511, that is, the covering part 511 and the mounting part 512 are in a bent state. The mounting part 512 is provided with a first mounting hole 5121, a second mounting hole 5122, a first mounting protrusion 5123 and a second mounting protrusion 5124. The first mounting hole 5121 and the first mounting protrusion 5123 are located at one end of the blade frame 51 close to the first side 11 in the first direction D1, and the second mounting hole 5122 and the second mounting protrusion 5124 are located at the other end of the blade frame 51 in the first direction D1. The first mounting hole 5121 and the second mounting hole 5122 are both through holes penetrating the mounting part 512. The first mounting protrusion 5123 protrudes in a direction away from the second side 12 along the first direction D1, and the second mounting protrusion 5124 protrudes in a direction away from the first side 11 along the first direction D1.

The blade 52 includes a second connection part 521, a contact part 522 and a bending part 523. The extension direction of the second connection part 521 is consistent with the extension direction of the mounting part 512. The second connection part 521 is configured to be connected to the mounting part 512 of the blade frame 51 by welding or gluing. The contact part 522 is substantially extended in the third direction D3 on the basis of the second connection part 521. The contact part 522 is configured to directly contact the roller body 1311 of the developing roller 131, thereby controlling the layer thickness of the developer adsorbed on the roller body 1311, and ensuring that the developer layer thickness transferred from the developing roller 131 to the photosensitive drum 921 is consistent each time. The bending part 523 is formed by bending and extending on the basis of the contact part 522, and the bending angle of the two is greater than 90°. The bending part 523 is conducive to guiding the developer. In some embodiments, the bending part 523 may not be provided. It is to be noted that the layer thickness regulating blade in the disclosed implementation is a steel blade, that is, the blade frame 51 and the blade 52 are both made of steel material. In some embodiments, the layer thickness regulating blade can be made of other materials.

It is to be noted that, when observed from the first direction D1, the layer thickness regulating blade is roughly L-shaped. If the L-shaped layer thickness regulating blade is surrounded by a complete rectangle, the rotation center of the coupling of the developing cartridge 1 is not within the rectangular range.

It is to be noted that in order to ensure that the blade 52 is more stably welded to the blade frame 51, spot welding is adopted in the disclosed implementation to ensure that the welding marks are more uniform. In some embodiments, other welding methods may be adopted.

The first side 11 of the casing 10 is provided with a first mounting groove 50 and a third mounting hole 56, and the second side 12 is provided with a second mounting groove 59 and a fourth mounting hole 57. The first mounting groove 50 and the second mounting groove 59 are grooves formed by the first side 11 and the second side 12 of the casing 10 in the third direction D3, respectively, and the third mounting hole 56 and the fourth mounting hole 57 are mounting holes formed by the recesses of the casing 10 in the second direction D2. A first mounting protrusion 5123 is inserted into the first mounting groove 50 and is limited by the first mounting groove 50, and the second mounting protrusion 5124 is inserted into a second mounting groove 59 and is limited by the second mounting groove 59, so as to facilitate the layer thickness regulating blade to be installed at a predetermined position of the developing cartridge 1.

The first mounting hole 5121 of the layer thickness regulating blade completely overlaps with the third mounting hole 56 on the casing 10 in the second direction D2, and the second mounting hole 5122 and the fourth mounting hole 57 completely overlap in the second direction D2. A first screw (not shown in the figures) can be inserted into the first mounting hole 5121 and the third mounting hole 56 at the same time, and a second screw (not shown in the figures) can be inserted into the second mounting hole 5122 and the fourth mounting hole 57 at the same time, so that the layer thickness regulating blade is fixedly installed on the casing 10. The disclosed embodiment does not limit the number of mounting holes and screws on the layer thickness regulating blade and the casing 10. In some embodiments, the layer thickness regulating blade and the casing 10 can each be provided with only one mounting hole or three or more mounting holes, or no mounting holes are provided, and the layer thickness regulating blade is installed to the casing 10 by gluing or welding.

The cover 151 is detachably arranged at the fifth side 15 of the developing cartridge 1. The cover 151 is configured to prevent the developer in the accommodating chamber from leaking. The cover 151 is provided with a layer thickness regulating blade mounting part 512 at one end close to the developing roller 131 in the second direction D2. The layer thickness regulating blade mounting part 512 is not provided with a groove. The layer thickness regulating blade mounting part 512 includes a first mounting wall 1511 and a second mounting wall 1512. The first mounting wall 1511 and the second mounting wall 1512 both extend in the first direction D1. The extension direction of the first mounting wall 1511 is substantially the same as the extension direction of the covering part 511 of the blade frame 51, and the extension direction of the second mounting wall 1512 is substantially the same as the extension direction of the mounting part 512 of the blade frame 51. When the layer thickness regulating blade is installed on the casing 10, the covering part 511 of the layer thickness regulating blade covers the first mounting wall 1511, and the mounting part 512 of the layer thickness regulating blade covers the second mounting wall 1512.

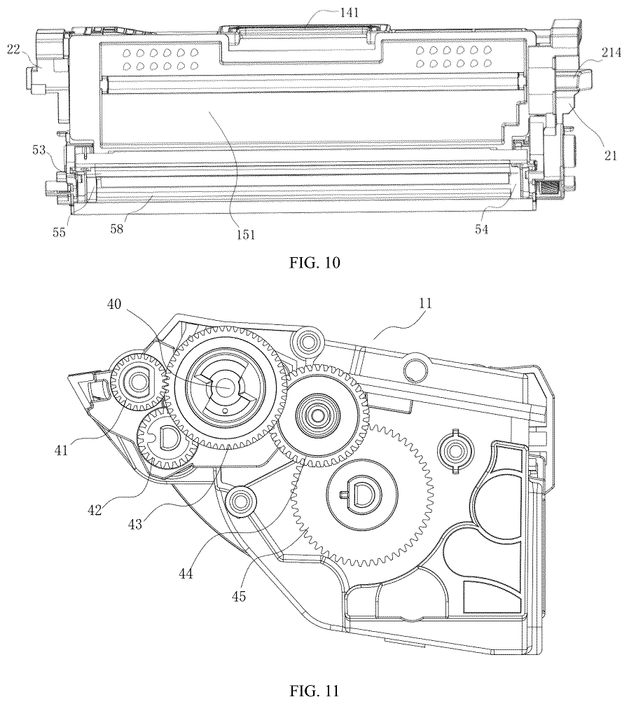

As shown in FIGS. 9 and 10, the developing cartridge 1 is further provided with a first seal 53, a second seal 54, a third seal 55 and a fourth seal 58. The first seal 53 and the fourth seal 58 are both block-shaped bodies extending along the first direction D1.

The first seal 53 is attached to the second mounting wall 1512 by gluing. In the second direction D2, the first seal 53 is located between the second mounting wall 1512 and the mounting part 512 of the blade frame 51. The first seal 53 can prevent the developer from leaking out of the casing 10 through a gap between the second mounting wall 1512 and the mounting part 512. In the first direction D1, one end of the first seal 53 close to the first side 11 is adjacent to the second seal 54, and one end of the first seal 53 close to the second side 12 is adjacent to the third seal 55.

The second seal 54 is pasted around and near the first side 11 along the rotation direction of the developing roller 131. In the first direction D1, the second seal 54 is closer to the first side 11 than the first seal 53. The third seal 55 is pasted around and near the second side 12 along the rotation direction of the developing roller 131. In the first direction D1, the third seal 55 is closer to the second side 12 than the first seal 53.

The two ends of the developing roller 131 in the first direction D1 are directly in contact with the second seal 54 and the third seal 55 respectively. The second seal 54 and the third seal 55 are configured to prevent the developer from leaking from the two ends of the developing roller 131. Along the radial direction of the developing roller 131, the developing roller 131 at least partially overlaps with the second seal 54 and the third seal 55. In the third direction D3, the second seal 54 and the third seal 55 are both provided with felt (not shown in the figures) behind them. In the rotation direction of the developing roller 131, the second seal 54 and the third seal 55 are flush with the felt behind them. In some embodiments, the felt may not be provided. In the third direction D3, the fourth seal 58 is located behind the developing roller 131. In the first direction D1, the end of the fourth seal 58 close to the first side 11 is adjacent to the second seal 54, and the end of the fourth seal 58 close to the second side 12 is adjacent to the third seal 55. The fourth seal 58 is configured to prevent the developer from leaking in the rotation direction of the developing roller 131 during the rotation of the developing roller 131. The fourth seal 58 and the first seal 53 have the same length in the first direction D1. In some embodiments, the fourth seal 58 and the first seal 53 may have different lengths in the first direction D1. The disclosed embodiment does not limit the number of seals, and in some embodiments, the number of seals can be set according to actual needs.

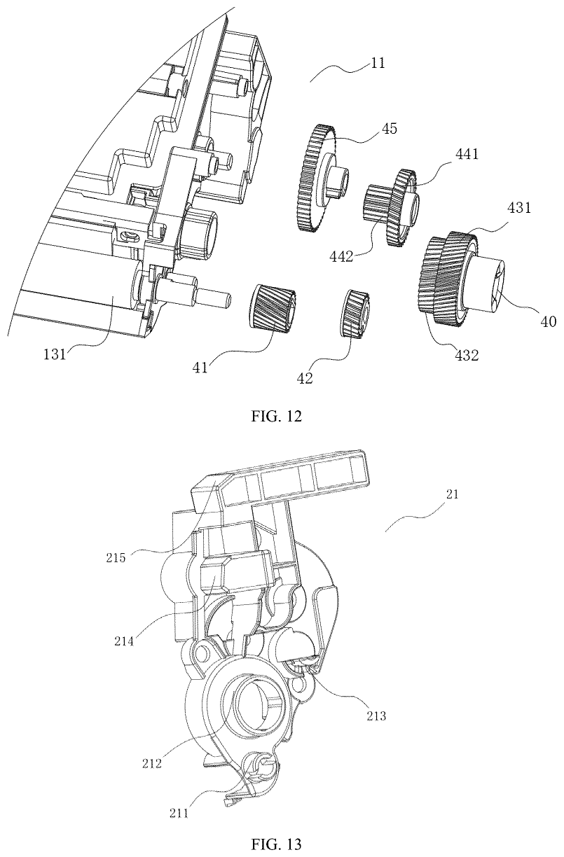

As shown in FIGS. 11-12, a transmission assembly is disposed at the first side 11 of the casing 10, and the transmission assembly includes a coupling rotatably installed on the first side 11 of the casing 10, and the rotation axis of the coupling is extending in the first direction D1. The coupling includes a coaxially integrally formed driving gear 43 and a force receiving part 40, and the driving gear 43 is closer to the first side 11 of the casing 10 than the force receiving part 40 in the first direction D1. The driving gear 43 includes a coaxially rotating large-diameter driving gear 431 and a small-diameter driving gear 432, and the large-diameter driving gear 431 is farther away from the first side 11 than the small-diameter driving gear 432 in the first direction D1. The force receiving part 40 is configured to be connected to the force output shaft on the image forming apparatus to receive the force output by the image forming apparatus.

The transmission assembly also includes a developing gear 41, a developer feeding gear 42, an idler gear 44 and an agitator gear 45. The developing gear 41 is fixedly installed on the D-shaped part of the first end 13121 of the roller shaft 1312 of the developing roller 131 and rotates coaxially with the developing roller 131. The developer feeding gear 42 is coaxially fixedly installed on one end of the developer feeding roller close to the first side 11 of the casing 10 and rotates together with the developer feeding roller. The agitator gear 45 is coaxially fixedly installed on one end of the agitator close to the first side 11 of the casing 10 and rotates together with the agitator. The idler gear 44 is rotatably installed on the first side 11 of the casing 10, and the idler gear 44 includes a large-diameter idler gear 441 and a small-diameter idler gear 442 that rotate coaxially. In the first direction D1, the large-diameter idler gear 441 is farther away from the first side 11 than the small-diameter idler gear 442.

The rotation axis of the agitator gear 45 is farther from the rotation axis of the driving gear 43 than the rotation axis of the idler gear 44. The developing gear 41 is meshed with the large-diameter driving gear 431, the developer feeding gear 42 is meshed with the large-diameter idler gear 441 and the small-diameter driving gear 432, and the small-diameter idler gear 442 is meshed with the agitator gear 45. The force receiving part 40 receives the force output by the image forming apparatus and drives the driving gear 43 to rotate. The driving gear 43 transmits the force to the developing gear 41, the developer feeding gear 42 and the idler gear 44 meshed therewith, so that the developing roller 131 and the developer feeding roller start to rotate, and the idler gear 44 transmits the force to the agitator gear 45 meshed therewith, so that the agitator starts to rotate and stirs the developer.

As shown in FIGS. 5 and 13-14, a protective cover 21 is located at the first side 11 of the casing 10. The protective cover 21 is fixedly installed on the casing 10 in a detachable manner. The protective cover 21 does not move relative to the casing 10. The protective cover 21 can move together with the casing 10, and the protective cover 21 does not axially limit the developer feeding roller.

The protective cover 21 includes a first guide member 211, a drive protection part 212, a first load-bearing part 213, a separator 214 and a first correction part 215. Each component can be integrally formed with the protective cover 21, or can be assembled and fixedly installed on the protective cover 21 in a detachable manner.

The first guide member 211 includes a first upper guide part and a first lower guide part, both of which protrude along the first direction D1 in a direction away from the first side 11, and are both arc-shaped, separated by a gap. That is, the first guide member 211 can be regarded as a cylinder divided into two arc-shaped protrusions along the radial direction, and a gap is located on the extension line of a line connecting the contact position between the developing roller 131 and the photosensitive drum 921 and the rotation axis of the developing roller 131. The rotation of the roller shaft 1312 can be observed through a gap between the first upper guide part and the first lower guide part to determine whether the developing roller 131 can work normally. It is also convenient for the first guide member 211 to be aligned with the roller shaft 1312 of the developing roller 131, thereby facilitating the installation of the protective cover 21.

The first guide member 211 surrounds the first end 13121 of the roller shaft 1312 of the developing roller 131 but does not contact the roller shaft 1312, so as to prevent the friction between the developing roller 131 and the first guide member 211 from affecting the normal operation of the developing roller 131 due to the rotation of the developing roller 131. In some embodiments, the first guide member 211 may contact the roller shaft 1312. In some embodiments, the first guide member 211 may be a complete hollow cylinder surrounding the first end 13121 of the developing roller 131, or the first guide member 211 may only include the first upper guide part or the first lower guide part. The shape of the first guide member 211 may be designed according to actual needs.

The drive protection part 212 is configured to protect the coupling. The drive protection part 212 includes a through hole that penetrates the protective cover 21 along the first direction D1. The through hole is configured to expose the force receiving part 40 so that the force receiving part 40 receives force output from the image forming apparatus. In the second direction D2, the drive protection part 212 is located above the first guide member 211.

The first load-bearing part 213 is a protrusion protruding outward along the first direction D1. In the disclosed implementation, the first load-bearing part 213 is an arc-shaped protrusion. In some embodiments, the first load-bearing part 213 can be other shapes. The first load-bearing part 213 includes an arc surface. The first load-bearing part 213 is configured to make the arc surface contact with the components in the drum cartridge 92 to support the weight of the developing cartridge 1 when the developing cartridge 1 is installed on the drum cartridge 92. In the third direction D3, the first load-bearing part 213 at least partially overlaps with the drive protection part 212.

The separator 214 is a protrusion protruding outward in the first direction D1. In the second direction D2, the separator 214 is at least partially farther away from the developing roller 131 than the drive protection part 212. When viewed from the second direction D2, the separator 214 at least partially overlaps with the drive protection part 212. In the third direction D3, the separator 214 is closer to the fifth side 15 relative to the sixth side 16. The separator 214 is configured to receive the separation force applied by the image forming apparatus to separate the developing roller 131 from the photosensitive drum 921.

The separator 214 includes a force-receiving part for receiving the separation force output by the image forming apparatus, where the force-receiving part includes a first force-receiving block 2141. The first force-receiving block 2141 is fixedly arranged at the first side 11, that is, the first force-receiving block 2141 cannot move relative to the casing 10. A first inclined surface 2142 is provided on the first force-receiving block 2141, and the first inclined surface 2142 can be abutted by the separation force output member 91 in the image forming apparatus to receive the separation force. The first inclined surface 2142 is an inclined surface or an arc surface whose extension direction intersects with the first direction D1. In the disclosed implementation, the first inclined surface 2142 is an inclined surface, but is not limited thereto. Further, the first inclined surface 2142 is inclined relative to the first direction D1, and the first inclined surface 2142 is inclined from left to right along the third direction D3 in the first direction D1 toward the developing roller 131. Further, the first inclined surface 2142 extends from left to right in the first direction D1 along the third direction D3 toward a direction close to the sixth side 16. That is, the starting end 21421 of the first inclined surface 2142 is closer to the second side 12 than the ending end 21422 in the first direction D1, and the starting end 21421 is farther away from the sixth side 16 in the third direction D3 than the ending end 21422. The angle a between the first inclined surface 2142 and the first direction D1 ranges from 38° to 58°, and is optionally 48° in the disclosed implementation.

When the first inclined surface 2142 receives the separation force, the first inclined surface 2142 moves together with the casing 10, so that the developing cartridge 1 moves in the third direction D3, and further moves in a direction away from the photosensitive drum 321, thereby separating the developing roller 131 from the photosensitive drum 921. It is to be noted that the separator 214 can be directly installed on the casing 10 or other components.

It is to be noted that the extension line L3 of a line connecting the rotation axis of the coupling and the rotation axis of the developing roller 131 passes through the first force-receiving block 2141. Further, the extension line L3 of the line connecting the rotation axis of the coupling and the rotation axis of the developing roller 131 passes through the first inclined surface 2142. After the developing cartridge 1 is installed on the drum cartridge 92, the end of the first side 11 adjacent to the developing roller 131 and the coupling can be supported by the drum cartridge 92 to a certain extent, so the first inclined surface 2142 can receive the separation force more stably.

The first correction part 215 is formed by extending along the third direction D3. In the second direction D2, the first correction part 215 is farther away from the developing roller 131 than the drive protection part 212. The first correction part 215 is used when the developing cartridge 1 is installed in the image forming apparatus. When the developing cartridge 1 is not installed properly, the first correction part 215 is abutted by components in the image forming apparatus, so that the developing cartridge 1 is moved by force and is located in the installed position.

As shown in FIGS. 15-18, the rear end of the developing cartridge 1 is provided with a first forced pushing part 23 at a position close to the first side 11, and the rear end of the developing cartridge 1 is provided with a second forced pushing part 24 at a position close to the second side 12. That is, the forced pushing part in the disclosed implementation includes a first forced pushing part 23 and a second forced pushing part 24, and the first forced pushing part 23 and the second forced pushing part 24 both include a substantially planar pressure receiving surface, and the pressure receiving surface is configured to directly contact the drum cartridge 92 to receive the forced pushing force applied by the drum cartridge 92 in the third direction D3. In the second direction D2, the distance L2 from the pressure receiving surface of the first forced pushing part 23 and the second forced pushing part 24 to the developing roller 131 is greater than the distance L1 from the first load-bearing part 213 to the developing roller 131.

In the disclosed implementation, the first forced pushing part 23 and the second forced pushing part 24 are both integrally formed with the casing 10 and do not protrude relative to the casing 10. In some embodiments, the first forced pushing part 23 and the second forced pushing part 24 can be detachably fixedly installed on the casing 10. The first forced pushing part 23 and the second forced pushing part 24 are overlapped in the first direction D1 to ensure that the force received at the position where the developing roller 131 contacts the photosensitive drum 921 is consistent. In some embodiments, the first forced pushing part 23 and the second forced pushing part 24 may not overlap, or only one forced pushing part is provided. After the developing cartridge 1 is installed on the drum cartridge 92 in the image forming apparatus, the first forced pushing part 23 is subjected to the forced pushing force applied by the first thrust member 9231 on the drum cartridge 92 in the third direction D3, and the second forced pushing part 24 is subjected to the forced pushing force applied by the second thrust member 9241 on the drum cartridge 92 in the third direction D3, so that the developing cartridge 1 has a tendency to approach the photosensitive drum 921 in the third direction D3, so that the developing roller 131 is in close contact with the photosensitive drum 921, thereby ensuring the imaging quality of the image forming apparatus.

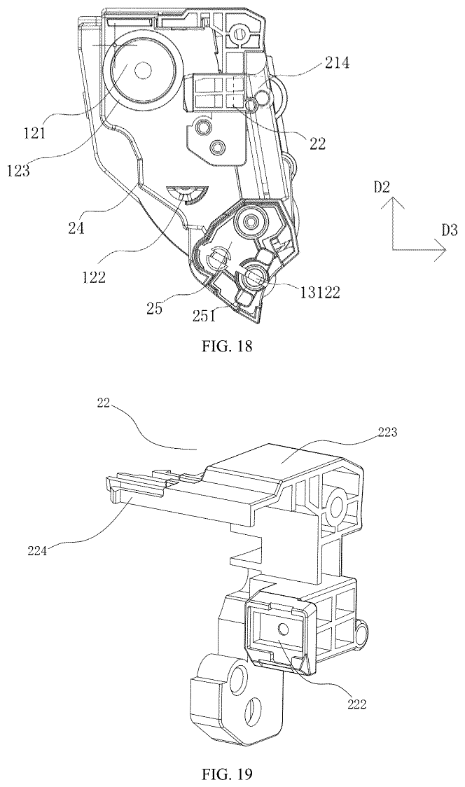

As shown in FIG. 18, the second side 12 of the casing 10 is provided with a second load-bearing part 122, and the second load-bearing part 122 extends in the first direction D1 in a direction away from the second side 12. The second load-bearing part 122 has the same function as the first load-bearing part 213, and both are in contact with the drum cartridge 92 to support the developing cartridge 1 when the developing cartridge 1 is installed on the drum cartridge 92. In other words, the load-bearing part in the disclosed implementation includes the first load-bearing part 213 and the second load-bearing part 122. In order to make the design of the developing cartridge 1 beautiful and maintain the balance of the developing cartridge 1 in the image forming apparatus, the second load-bearing part 122 has the same shape as the first load-bearing part 213, both are arc-shaped protrusions, and the second load-bearing part 122 and the first load-bearing part 213 are overlapped in the first direction D1.

When the developing cartridge 1 is installed on the drum cartridge 92 of the image forming apparatus, the first load-bearing part 213 contacts a first platform part 9232 on the drum cartridge 92, and the second load-bearing part 122 contacts a second platform part 9246, so that the developing cartridge 1 is stably installed on the drum cartridge 92. In some embodiments, the second load-bearing part 122 and the first load-bearing part 213 may have different shapes, and the second load-bearing part 122 and the first load-bearing part 213 may not overlap, or only one load-bearing part is provided. It is to be noted that in the second direction D2, the distance from the pressure receiving surface of the first forced pushing part 23 and the second forced pushing part 24 to the developing roller 131 is greater than the distance from the second load-bearing part 122 to the developing roller 131.

As shown in FIGS. 5, 16, and 18-20, the identification component includes a holder 22 and a storage medium 221. The storage medium 221 is configured to store information such as the model and usage of the developing cartridge 1. The storage medium 221 is detachably installed on the holder 22. The storage medium 221 includes an electrical contact surface for contacting the electrical contact 9242 in the image forming apparatus. The electrical contact surface is toward the sixth side 16 in the third direction D3. The storage medium 221 transmits the information of the developing cartridge 1 to the image forming apparatus through the electrical contact surface, so that the developing cartridge 1 is identified by the image forming apparatus.

The holder 22 is detachably fixedly installed on the second side 12 of the casing 10 in the first direction D1. The holder 22 includes a receiving part 222, a second correction part 223, an insertion part 224 and a guide part 225. Each component can be integrally formed with the holder 22 or separate components can be combined.

The receiving part 222 is located below the second correction part 223 in the second direction D2. The receiving part 222 is a groove that is recessed in the third direction D3. The receiving part 222 is configured to accommodate the storage medium 221. In some embodiments, the storage medium 221 and the holder 22 cannot move relative to the casing 10. The second correction part 223 has the same function as the first correction part 215. When the developing cartridge 1 is placed in the image forming apparatus, when the developing cartridge 1 is not installed in place, the second correction part 223 is abutted by the components in the image forming apparatus, so that the developing cartridge 1 is moved by force and is positioned in the installed position. The second correction part 223 also has a part extending in the third direction D3. In some embodiments, the first correction part 215 and the second correction part 223 may not be provided, and the developing cartridge 1 is placed in the installed position by artificially applying force, or only one correction part is provided.

The insertion part 224 is a snap-fitting member extending in the first direction D1. The holder 22 is inserted into the groove on the casing 10 through the insertion part 224 so as to be installed on the casing 10, and then fixed by screws. The receiving part 222 and the guide part 225 are located on different sides of the holder 22 in the third direction D3. The guide part 225 is a cylinder extending along the first direction D1. The guide part 225 includes a circumferential surface. When the holder 22 is installed in the casing 10, when the developing cartridge 1 is installed to the image forming apparatus roughly along the second direction D2, the guide part 225 is configured to contact the protrusion 9243 on the drum cartridge 92, that is, the circumferential surface of the guide part 225 contacts the protrusion 9243, and is guided by the protrusion 9243 during the installation process. The holder 22 is installed to a predetermined position along the extension direction of the protrusion 9243, and the storage medium 221 contacts the electrical contact 9242, so as to ensure that the developing cartridge 1 is recognized by the image forming apparatus. In the disclosed implementation, in order to enable the storage medium 221 to be smoothly located in the contact position with the electrical contact 9242 and reduce the friction generated by the contact between the guide part 225 and the protrusion 9243, the guide part 225 is configured as a cylinder, and the cylindrical surface of the cylinder is in contact with the protrusion 9243. In some embodiments, the guide part 225 may be configured as other shapes, or the guide part 225 may not be configured.

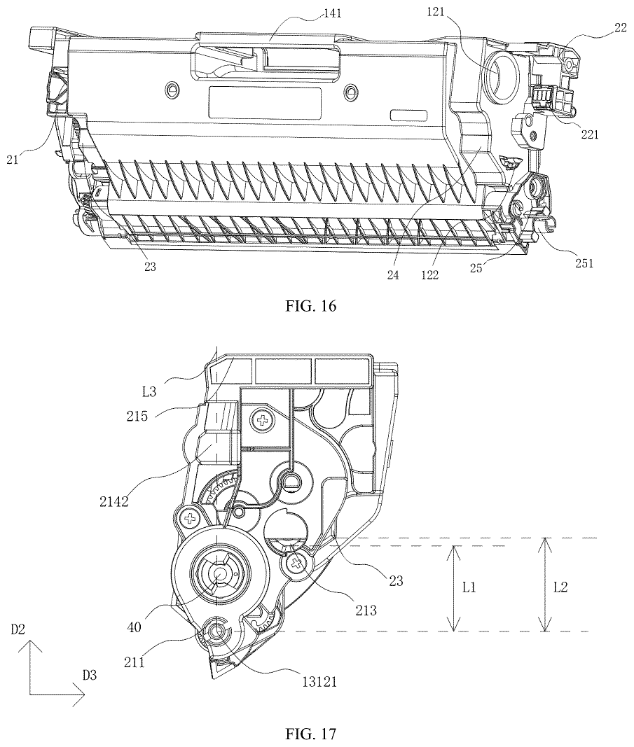

As shown in FIGS. 16 and 18, the casing 10 is also provided with a developer filling port 121 and a developer filling cover 123. The developer filling port 121 is a through hole that penetrates the second side 12 of the casing 10 along the first direction D1. The developer is poured into the accommodating chamber of the casing 10 through the developer filling port 121. The developer filling cover 123 is a cover member that is provided to match the shape of the through hole of the developer filling port 121. In the disclosed implementation, the developer filling port 121 and the developer filling cover 123 are both circular, and may be other shapes in some embodiments. After the developer is poured into the accommodating chamber, in order to prevent the developer from leaking through the developer filling port 121, the developer filling cover 123 completely covers the developer filling port 121. That is, the developer filling port 121 and the developer filling cover 123 completely overlap in the first direction D1. It can be seen that the developer filling cover 123 located at the second side 12 has no overlap or interference with the holder 22.

As shown in FIGS. 16, 18 and 21, a first bearing 25 is provided at the second side 12 of the casing 10. The first bearing 25 is detachably fixed on the second side 12 by screws. The first bearing 25 includes a second guide member 251, a developing hole 252, a developer feeding hole 253 and a main body 254. The main body 254 is a plate-like member. The second guide member 251, the developing hole 252 and the developer feeding hole 253 can be integrally formed with the main body 254, or can be detachably installed on the main body 254. The second guide member 251 protrudes from the main body 254 along the first direction D1 in a direction away from the second side 12. The second guide member 251 does not move relative to the casing 10. The second guide member 251 includes a second upper guide part and a second lower guide part. The second upper guide part and the second lower guide part are separated by a gap. The gap is located on the extension line of the line connecting the contact position of the developing roller 131 and the photosensitive drum 921 and the rotation axis of the developing roller 131. The second upper guide part and the second lower guide part are both arc-shaped protrusions. The second guide member 251 has the same shape as the first guide member 211, and the two can be regarded as a cylinder divided into two arc-shaped protrusions along the radial direction. The second guide member 251 surrounds the second end 13122 of the developing roller 131. The installation alignment of the first bearing 25 and the roller shaft 1312 of the developing roller 131 can be observed through the gap between the second upper guide part and the second lower guide part, and the rotation of the roller shaft 1312 can also be observed.

The second guide member 251 and the first guide member 211 together form a guide assembly, which guides the developing cartridge 1 during the process of installing the developing cartridge 1 to the image forming apparatus, so that the developing cartridge 1 can be smoothly installed on the image forming apparatus. When viewed from the first direction D1, the second guide member 251 and the first guide member 211 are overlapped to maintain the balance of the developing cartridge 1 during the installation process, so that the developing cartridge 1 can be installed more stably. In some embodiments, the second guide member 251 and the first guide member 211 may not overlap, or only one guide member is provided. In some embodiments, the second guide member 251 can be a complete hollow cylinder surrounding the second end 13122 of the developing roller 131, or the second guide member 251 only includes a second upper guide part or a second lower guide part. The shape of the second guide member 251 can be set according to actual needs.

The developing hole 252 and the developer feeding hole 253 are both through holes penetrating the main body 254 along the first direction D1. The second end 13122 of the developing roller 131 is inserted into the developing hole 252, the second end 13122 passes through the second side 12 and is partially located outside the second side 12, and the second end 13122 is rotatably supported by the developing hole 252. One end of the developer feeding roller located at the second side 12 in the first direction D1 is inserted into the developer feeding hole 253, so that one end of the developer feeding roller located at the second side 12 in the first direction D1 is rotatably supported by the first bearing 25.

It is to be noted that the first bearing 25 is made of conductive material. That is, the second guide member 251 of the first bearing 25 in the disclosed implementation is the electrical receiving part of the developing cartridge 1, and the second guide member 251 can contact the electrode 9245 to receive the electric energy output from the image forming apparatus, and transmit the electric energy to the first bearing 25. The first bearing 25 transmits the electric energy to the developing roller 131 and the developer feeding roller supported by the first bearing 25, so that the developing roller 131 and the developer feeding roller are charged, so that the developing roller 131 and the developer feeding roller absorb the developer.

As shown in FIGS. 22-23, after the developing cartridge 1 is installed on the drum cartridge 92 of the image forming apparatus, the separator 214 on the developing cartridge 1 is located at a first position in the first spacer 9233 of the drum cartridge 92. In the third direction D3, the separator 214 is closer to the first groove wall 92331 relative to the second groove wall 92332, and the developing roller 131 on the developing cartridge 1 and the photosensitive drum 921 on the image forming apparatus are in a close contact state, so that the developing roller 131 can better provide developer to the photosensitive drum 921.

As shown in FIGS. 5 and 24-25, when the image forming apparatus does not need the developing cartridge 1 to work, the image forming apparatus will issue a command to make the developing roller 131 and the photosensitive drum 921 out of contact to prevent the developing roller 131 and the photosensitive drum 921 from being damaged due to long-term contact.

The separation force output member 91 of the image forming apparatus begins to move leftward along the first direction D1 and begins to abut against the first inclined surface 2142 of the separator 214. The separation force output member 91 applies a separation force to the separator 214. Since the first inclined surface 2142 is an inclined surface inclined relative to the first direction D1, the separation force output member 91 can abut against different positions of the first inclined surface 2142 during the process of moving in the first direction D1. That is, the separation force output member 91 moves on the first inclined surface 2142 from the ending end 21422 to the starting end 21421 relative to the first inclined surface 2142. Since the starting end 21421 is farther away from the sixth side 16 than the ending end 21422 in the third direction D3, and the first inclined surface 2142 decomposes the separation force into a force extending in the third direction D3 and transmits the force to the casing 10. The separator 214 moves backward in the third direction D3 during the process of continuous abutment by the separation force output member 91, thereby driving the developing cartridge 1 to move backward in the third direction D3.

Further, the casing 10 is pivoted with the position where the left end of the developing roller 131 (located at one end of the second side 12) contacts the left end of the photosensitive drum 921 as a pivot point, so that the first side 11 moves backward in a swinging manner, and then the right end of the developing roller 131 (located at the other end of the first side 11) swings backward to move to a position where the developing roller 131 is separated from the photosensitive drum 921. In the disclosed implementation, the left end is defined as the end close to the second side 12, and the right end is defined as the end away from the second side 12.

When the separation force output member 91 stops moving, the separation force output member 91 still maintains an abutment relationship with the separator 214, and the separator 214 is located at a second position of the first spacer 9233. In the third direction D3, the distance between the separator 214 and the first groove wall 92331 when the separator 214 is at the second position is greater than the distance between the separator 214 and the first groove wall 92331 when the separator 214 is at the first position.

It is to be noted that when the separator 214 is driven by the abutment to move the developing cartridge 1 backward in the third direction D3, in order to make the movement of the developing cartridge 1 smoother and more stable, the first load-bearing part 213 moves backward in the extension direction of the first platform part 9232, and the second load-bearing part 122 moves backward in the extension direction of the second platform part 9246. In the disclosed implementation, the moving distances of the first load-bearing part 213 and the second load-bearing part 122 are different. In some embodiments, the moving distances of the first load-bearing part 213 and the second load-bearing part 122 may be the same.

It is to be noted that when the separator 214 is driven by the abutment to move the developing cartridge 1 backward in the third direction D3, the developing roller 131 and the photosensitive drum 921 gradually change from a close contact state to a disengaged state. That is, the developing roller 131 is constantly moving away from the photosensitive drum 921. When the separator 214 is located at the second position of the first spacer 9233, the right end of the developing roller 131 is completely disengaged from the photosensitive drum 921 and remains disengaged while the separation force output member 91 is in abutment with the separator 214.

It is to be noted that when the separator 214 is abutted to drive the developing cartridge 1 to move backward in the third direction D3, the first forced pushing part 23 and the second forced pushing part 24 on the developing cartridge 1 respectively keep in contact with the first thrust member 9231 and the second thrust member 9241, and make the first thrust member 9231 and the second thrust member 9241 move backward in the third direction D3. In the disclosed implementation, the first thrust member 9231 and the second thrust member 9241 move backward in the third direction D3 by different distances. In some embodiments, the first thrust member 9231 and the second thrust member 9241 move backward in the third direction D3 by the same distance.

When the developing cartridge 1 runs again, the image forming apparatus sends a command to make the separation force output member 91 move to the right along the first direction D1, and the separator 214 is no longer abutted by the separation force output member 91. Under the elastic action of the first thrust member 9231 and the second thrust member 9241, the developing cartridge 1 moves forward along the third direction D3, and the developing roller 131 is in close contact with the photosensitive drum 921. The developing cartridge 1 runs normally in the image forming apparatus.

### Embodiment 2

Except for the parts specially described, the other parts of Embodiment 2 are the same as those of Embodiment 1.

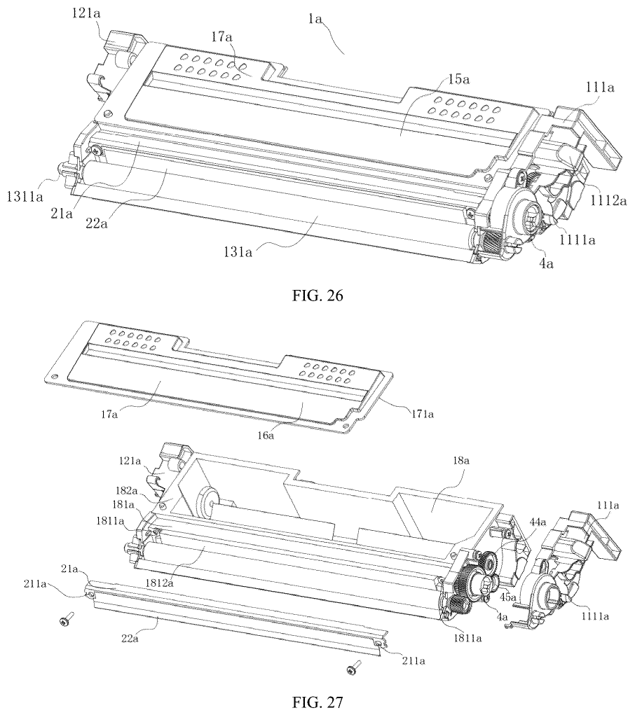

As shown in FIG. 26, the disclosed embodiment shows a specific structure of a casing 1a, which includes a cover 17a and a shell 18a. The cover 17a and the shell 18a can be fixedly connected together by welding, bonding, screw connection, etc. In the disclosed implementation, the cover 17a and the shell 18a are connected together by an ultrasonic welding process to form the casing 1a. The accommodating chamber 19a is located in the space formed by the cover 17a and the shell 18a. The first side 11a, the second side 12a, the third side 13a, the fourth side 14a, and the sixth side 16a of the casing 1a are formed by the shell 18a, and the fifth side 15a of the casing 1a is formed by the cover 17a.

As shown in FIG. 27, a developer outlet is formed at the lower end of the casing 1a, and a support part 181a is integrally formed on the shell 18a. The support part 181a extends between the first side 11a and the second side 12a of the casing 1a and is connected to the first side 11a and the second side 12a. The support part 181a is configured to support and fix the installation of the blade frame 21a. The support part 181a is provided with at least one first positioning hole 1811a. The first positioning hole 1811a is used for screw insertion. At least one second positioning hole 211a is formed on the blade frame 21a, and the second positioning hole 211a is aligned with the first positioning hole 1811a. The blade frame 21a is fixedly installed on the support part 181a by means of screws, and the screws pass through the second positioning hole 211a and are inserted into the first positioning hole 1811a along the second direction D2, thereby fixing the blade frame 21a on the support part 181a. In the disclosed implementation, the numbers of the first positioning holes 1811a and the second positioning holes 211a are both two, and they are symmetrically arranged at the two ends of the blade frame 21a in the first direction D1. Thus, the blade frame 21a is supported by the first side 11a and the second side 12a, and the blade frame 21a is fixed on the support part 181a. The strength of the blade frame 21a itself can prevent the support part 181a from being deformed when subjected to external force, thereby preventing the shell 18a from being deformed.

The cover 17a is provided with a first welding surface 171a, and the shell 18a is provided with a second welding surface 182a aligned with the first welding surface 171a in the third direction D3. After the cover 17a is assembled to the shell 18a, the first welding surface 171a and the second welding surface 182a overlap, and the projection of the coupling in the first direction D1 does not overlap with the first welding surface 171a and the second welding surface 182a. This allows the coupling to be installed on the shell 18a first and then welded to the cover 17a. In addition, the cover 17a will not touch the coupling during the assembly of the cover 17a to the shell 18a, so that the coupling is prevented from being hit by the cover 17a and falling off.

As shown in FIG. 29, a partition wall 183a is integrally formed on the sixth side 16a of the casing 1a, and the partition wall 183a and the support part 181a divide the accommodating chamber 19a into a developing chamber 192a and a developer accommodating chamber 191a. In the second direction D2, the developing chamber 192a is located below the developer accommodating chamber 191a, and a connecting port 193a is formed between the support part 181a and the partition wall 183a. The connecting port 193a connects the developer accommodating chamber 191a and the developing chamber 192a. The developing roller 131a and the developer feeding roller 132a are rotatably arranged in the developing chamber 192a, and the agitator 31a is rotatably arranged in the developer accommodating chamber 191a. The developer outlet is located at the lower end of the developing chamber 192a and the developing chamber 192a is connected to the outside of the casing 1a through the developer outlet. The circumferential surface of the developing roller 131a is exposed to the outside of the casing 1a through the developer outlet. The support part 181a is configured to prevent excessive developer in the developer accommodating chamber 191a from entering the developing chamber 192a, thereby causing excessive developer to accumulate at the developer feeding roller 132a and the developing roller 131a, thereby increasing the rotational resistance.

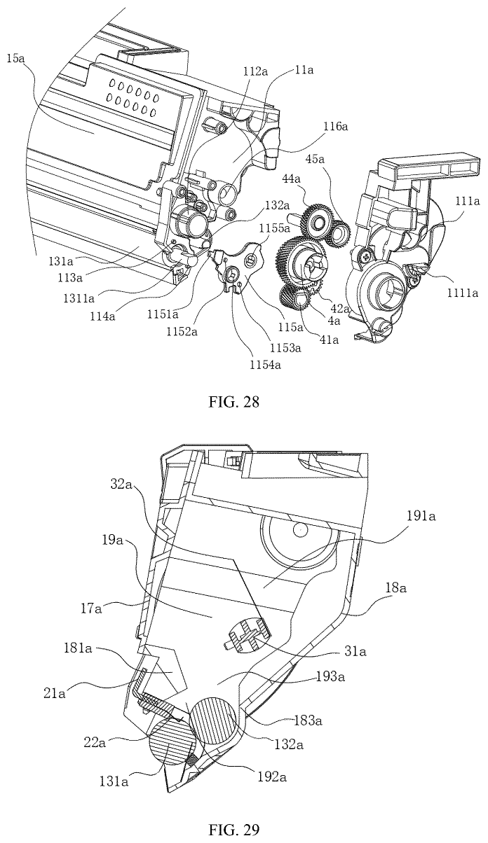

As shown in FIGS. 28 and 29, the disclosed embodiment shows a specific structure of an agitator 31a. An agitator gear 45a is coaxially fixedly installed on the right end of the agitator 31a. The agitator 31a rotates together with the agitator gear 45a. An agitator blade 32a is fixedly installed on the agitator 31a. The agitator blade 32a rotates together with the agitator 31a. When the agitator 31a rotates, the agitator blade 32a is driven to rotate, thereby stirring the developer in the accommodating chamber 19a.

The rotation axis of the agitator 31a is located between the rotation axis of the developing roller 131a and the handle 141a in the second direction D2, the rotation axis of the agitator 31a is located between the electrical contact surface 7a and the rotation axis of the developing roller 131a in the second direction D2, the rotation axis of the agitator 31a is located between the separator 1112a and the rotation axis of the developing roller 131a in the second direction D2, and the rotation axis of the agitator 31a is located between the first forced pushing part 161a and the separator 1112a or the second forced pushing part 162a and the separator 1112a in the third direction D3.

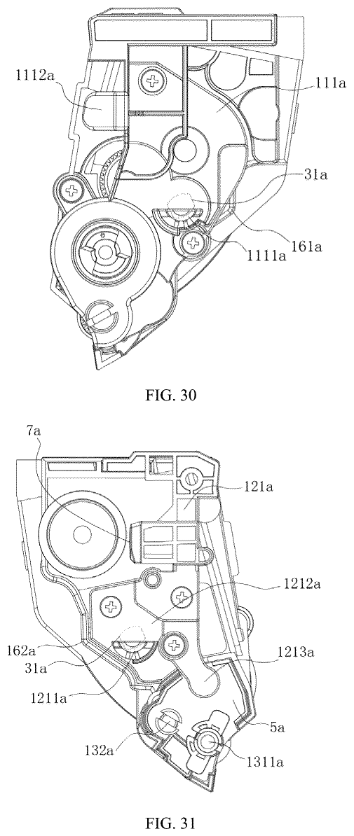

As shown in FIGS. 30 and 31, the projections of the first load-bearing part 1111a and the second load-bearing part 1211a in the first direction D1 overlap with the projection of the agitator 31a in the first direction D1, which can be completely overlapped or partially overlapped, and is partially overlapped in the disclosed implementation. Through the above design, the agitator 31a is closer to the developing roller 131a and the developer feeding roller 132a compared with the existing cartridges, so that the developer accumulated at the connecting port 193a and the developer feeding roller 132a can be more fully stirred to avoid agglomeration and excessive accumulation. In addition, the agitator gear 45a can be arranged closer to the developing roller 131a gear and the developer feeding roller 132a gear, so that the gear arrangement is more compact, which is conducive to the miniaturization of the developing device.

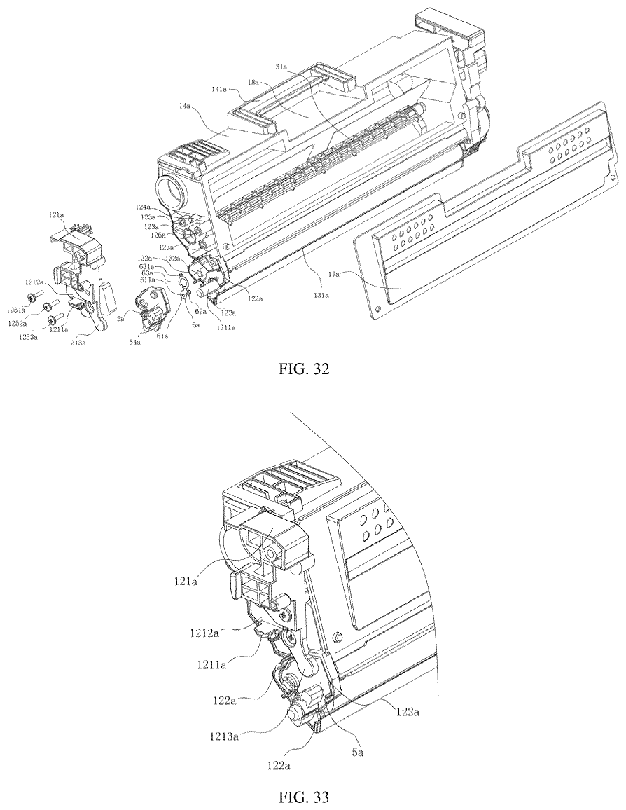

As shown in FIGS. 28 and 32, a circular first agitator support hole 116a and a second agitator support hole 126a are opened on the first side 11a and the second side 12a of the casing 1a along the first direction D1. The first agitator support hole 116a penetrates the first side 11a of the casing 1a along the first direction D1, and the second agitator support hole 126a penetrates the second side 12a of the casing 1a along the first direction D1. The two ends of the agitator 31a in the first direction D1 are respectively inserted into the first agitator support hole 116a and the second agitator support hole 126a and are rotatably supported by the first agitator support hole 116a and the second agitator support hole 126a. A sealing ring is also provided on the agitator 31a. The sealing ring is squeezed by the agitator 31a and the first agitator support hole 116a and the second agitator support hole 126a to produce deformation and then seal the first agitator support hole 116a and the second agitator support hole 126a to prevent leakage of the developer in the developer accommodating chamber 191a. At the same time, since the agitator 31a needs to generate rotational motion, in order to prevent the sealing ring from slipping out of the first agitator support hole 116a during the rotation of the agitator 31a, the agitator gear 45a is sleeved on the agitator 31a and at the same time, it will also have a limiting effect on the sealing ring in the first agitator support hole 116a, preventing the sealing ring from slipping out of the first agitator support hole 116a.

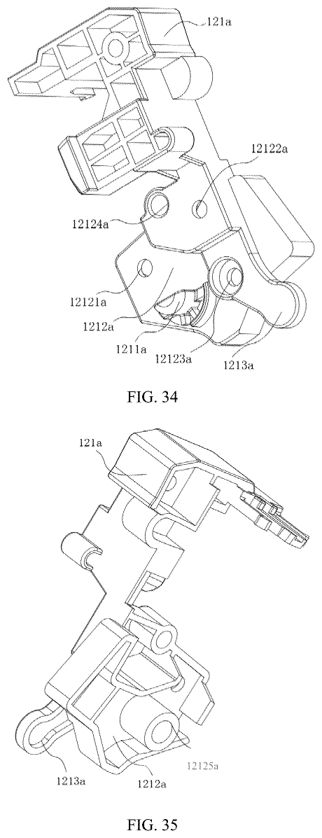

As shown in FIGS. 31, 32, 33, 34 and 35, the disclosed embodiment also shows a specific structure of a holder 121a and a first bearing 5a. Compared with the holder in Embodiment 1, the holder 121a in the disclosed implementation includes a cover part 1212a, which is integrally formed on the holder 121a. The projection of the cover part 1212a in the first direction D1 covers the projection of the second agitator support hole 126a in the second direction D2. The cover part 1212a is integrally formed with a position-limiting column 12125a on one side facing the casing 1a. The position-limiting column 12125a is inserted into the second agitator support hole 126a to prevent the sealing ring in the second agitator support hole 126a from slipping out of the second agitator support hole 126a. The second load-bearing part 1211a is integrally formed on the cover part 1212a.

The cover part 1212a is also provided with a first screw hole 12121a, a second screw hole 12122a, and a third screw hole 12123a, which are connected in pairs to form a triangle. The second side 12a of the casing 1a is provided with three screw columns 123a which correspond to the first screw hole 12121a, the second screw hole 12122a, and the third screw hole 12123a one by one. Screws pass through the first screw hole 12121a, the second screw hole 12122a, and the third screw hole 12123a along the first direction D1 and are inserted into the screw columns 123a, thereby fixing the cover part 1212a to the second side 12a of the casing 1a, and further fixing the holder 121a to the second side 12a of the casing 1a. The cover part 1212a is also provided with a third positioning hole 12124a, and the second side 12a of the casing 1a is integrally formed with a first positioning post 124a protruding to the left along the first direction D1. The first positioning post 124a is inserted into the third positioning hole 12124a, so that the cover part 1212a and the holder 121a are first positioned by the first positioning post 124a and the third positioning hole 12124a during assembly, so as to avoid the difficulty in aligning the first screw hole 12121a, the second screw hole 12122a, the third screw hole 12123a and the screw column 123a when installing the screws. The cover part 1212a is located between the electrical contact surface 7a and the developing roller 131a in the second direction D2.

A positioning part 1213a is also integrally formed on the cover part 1212a. The positioning part 1213a is formed by extending integrally downward from the cover part 1212a along the second direction D2. The positioning part 1213a is located between the cover part 1212a and the developing roller 131a in the second direction D2.

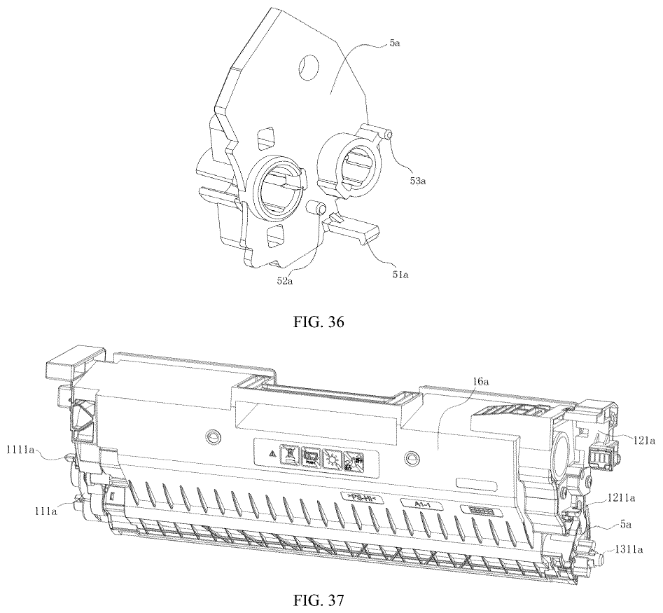

As shown in FIG. 36, in the disclosed implementation, no screw hole is provided on the first bearing 5a, so the first bearing 5a is not fixed to the casing 1a by screws. A positioning flange 122a of a shape and size that can fit the edge of the first bearing 5a is integrally formed on the second side 12a of the casing 1a, so that the positioning flange 122a surrounds the first bearing 5a, so that the first bearing 5a is positioned in the second direction D2 and the third direction D3. A third buckling part 51a is also provided on the first bearing 5a, and a third buckling fitting portion that matches the third buckling part 51a is provided on the second side 12a of the casing 1a. The third buckling part 51a is integrally formed and extends rightward from the first bearing 5a along the first direction D1, and the third buckling fitting portion is in the shape of a through hole, and the third buckling part 51a is inserted into the third buckling fitting portion, so as to produce a positioning effect on the first bearing 5a in the first direction D1. Further, the projection of the positioning part 1213a in the first direction D1 at least partially overlaps with the first bearing 5a and the positioning part 1213a abuts against the left end surface of the first bearing 5a, so that the positioning part 1213a can press the first bearing 5a against the second side 12a of the casing 1a, further preventing the first bearing 5a from falling off from the second side 12a of the casing 1a to the left in the first direction D1. The first bearing 5a is located between the positioning part 1213a and the second side 12a of the casing 1a in the first direction D1. Through the above design, the first bearing 5a does not need to be fixed to the casing with screws, which reduces the use of screws, reduces costs, and simplifies the assembly process.

In the disclosed implementation, the first correction part and the second correction part are eliminated, thereby simplifying the structure of the developing cartridge.

As shown in FIG. 28, the disclosed embodiment also discloses a specific structure of a second bearing 115a. The second bearing 115a is installed on the first side 11a of the casing 1a, and the second bearing 115a is provided with a second developing hole 1154a for inserting the roller shaft 1311a of the developing roller 131a, and a second developer feeding hole 1155a for inserting the developer feeding roller 132a. The second developing hole 1154a and the second developer feeding hole 1155a can rotatably support the right end of the developer feeding roller 132a and the developing roller 131a, and the second bearing 115a can rotatably support the developer feeding roller 132a and the left end of the developing roller 131a, so that the left and right ends of the developing roller 131a and the developer feeding roller 132a are rotatably supported, so that the developing roller 131a and the developer feeding roller 132a can rotate in the casing 1a. A fourth positioning hole 1152a and a fifth positioning hole 1153a are formed on the second bearing 115a, and a second positioning post 113a and a third positioning post 114a are integrally formed on the first side 11a of the casing 1a. The second positioning post 113a is located on the upper side and front side of the third positioning post 114a, and the rotation axis of the developing roller 131a is located between the second positioning post 113a and the third positioning post 114a. The second positioning post 113a is inserted into the fourth positioning hole 1152a, and the third positioning post 114a is inserted into the fifth positioning hole 1153a. The fourth positioning hole 1152a is a round hole, and the fifth positioning hole 1153a is a waist-shaped hole, so that the second bearing 115a is positioned by the second positioning post 113a and the third positioning post 114a during installation. At the same time, since the fifth positioning hole 1153a is a waist-shaped hole, the problem of the fifth positioning hole 1153a and the third positioning post 114a being unable to be aligned and inserted due to errors caused by manufacturing tolerances can be avoided. The second bearing 115a is also integrally formed with a first snap-fitting part 1151a and a second snap-fitting part extending leftward from the left end surface of the second bearing 115a. The first side 11a of the casing 1a is provided with a first snap-fitting matching part and a second snap-fitting matching part in the form of a through hole. The first snap-fitting part 1151a is inserted into the first snap-fitting matching part and abuts against the first snap-fitting matching part, and the second snap-fitting part is inserted into the second snap-fitting matching part and abuts against the second snap-fitting matching part, so that the second bearing 115a is positioned in the first direction D1 to prevent the second bearing 115a from falling out to the right in the first direction D1. Further, the protective cover 111a is assembled on the first side 11a of the casing 1a and is pressed against the second bearing 115a to further prevent the second bearing 115a from falling out to the right of the casing 1a. At the same time, the first positioning post 124a and the second positioning post 113a position the second bearing 115a in the second direction D2 and the third direction D3, so that the second bearing 115a can be firmly installed on the first side 11a of the casing 1a.

A driving support shaft 112a is integrally formed on the first side 11a of the casing 1a, and the coupling is rotatably installed on the driving support shaft 112a. The driving support shaft 112a is spaced apart from the second bearing 115a, thereby avoiding that the second bearing 115a may be displaced relative to the casing 1a due to the second bearing 115a being assembled on the casing 1a. Therefore, if the driving support shaft 112a is integrally formed on the second bearing 115a, the coupling may be displaced relative to the casing 1a, resulting in difficulty in aligning the force receiving unit 4a on the coupling with the force output shaft in the image forming apparatus, thereby affecting the reception of force.

The disclosed embodiment also discloses a specific structure of a transmission assembly, which is different from Embodiment 1 in that the idler gear 44a has only a primary gear, and the idler gear 44a meshes with the driving gear and then with the agitator gear 45a, thereby simplifying the structure of the transmission assembly and facilitating the miniaturization of the casing 1a.

As shown in FIG. 37, the disclosed embodiment further discloses a specific structure of a protective cover 111a, and the developer feeding gear 42a is covered by the protective cover 111a, that is, the developer feeding gear 42a will not be exposed by the protective cover 111a, thereby preventing the developer feeding gear 42a from being damaged by external collision.

As shown in FIGS. 32, 33 and 36, the disclosed embodiment further discloses a specific structure of an electric receiving part. In the disclosed implementation, the left end of the roller shaft 1311a of the developing roller 131a extends to the left from the second guide member 54a, so that when the developing cartridge is installed on the drum cartridge 92, the roller shaft 1311a of the developing roller 131a directly contacts the electrode in the drum cartridge 92, so that The roller shaft 1311a of the developing roller 131a serves as an electric receiving portion to receive electric energy transmitted from the electrode on the drum cartridge 92, so that the roller shaft 1311a is charged, and then the developing roller 131a is charged. The second side 12a of the casing 1a is also installed with a conductive member 6a made of conductive material (e.g., a steel sheet in the disclosed implementation, but conductive resin, copper sheet and other materials can also be used according to some embodiments). The conductive member 6a includes a first electrical contact part 62a, a second electrical contact part 63a and an integrally formed electrical connection part 61a connected to the first electrical contact part 62a and the second electrical contact part 63a. The first electrical contact part 62a abuts against the circumferential surface of the roller shaft 1311a of the developing roller 131a, the second electrical contact part 63a is annular and is sleeved on the left end of the developer feeding roller 132a and abuts against and is electrically connected to the developer feeding roller 132a. The electrical connection part 61a is provided with a sixth positioning hole 611a. A fourth positioning post 52a protruding to the right is integrally formed on the surface of the first bearing 5a facing the second side 12a of the casing 1a, and the fourth positioning post 52a is inserted into the sixth positioning hole 611a, so as to position the conductive member 6a in the second direction D2 and the third direction D3. A seventh positioning hole 631a is also integrally formed on the second electrical contact part 63a, and a fifth positioning post 53a protruding to the right is integrally formed on the surface of the first bearing 5a facing the second side 12a of the casing 1a. The fifth positioning post 53a is inserted into the seventh positioning hole 631a, so as to further position the conductive member 6a in the second direction D2 and the third direction D3. The seventh positioning hole 631a and the sixth positioning hole 611a are arranged relative to each other about the rotation axis of the developer feeding roller 132a. In the disclosed implementation, the first bearing 5a is made of insulating material. When the first bearing 5a is installed on the second side 12a of the casing 1a, the first bearing 5a presses the conductive member 6a between the second side 12a of the casing 1a and the first bearing 5a, thereby realizing the positioning of the first bearing 5a in the first direction D1. The projection of the conductive member 6a in the first direction D1 does not overlap with the projection of the support part 181a in the first direction D1. The projection of the conductive member 6a in the first direction D1 does not overlap with the projection of the partition wall 183a in the first direction D1, and the rotation axis of the coupling does not pass through the conductive member 6a. Thus, the volume of the conductive member 6a is minimized, space is saved, the cost of raw materials is reduced, the structure is simplified, and the conductive member 6a can be stably and firmly installed on the second side 12a of the casing 1a.

Compared with the existing technologies, the present disclosure can prevent the photosensitive drum from being in contact with the developing roller all the time, which would cause the photosensitive drum to transport unnecessary developer to the transfer belt in the image forming apparatus and contaminate the transfer belt, and also prevent the developing roller or photosensitive drum from being deformed or damaged due to long-term contact.

The foregoing describes in detail the structure, features and effects of the present disclosure based on the embodiments shown in the drawings. The above are merely some embodiments of the present disclosure, but the present disclosure is not limited to the scope of embodiments shown in the drawings. Any changes made according to the concept of the present disclosure, or modifications to equivalent embodiments with equivalent changes, which still do not exceed the spirit covered by the description and drawings, should be within the protection scope of the present disclosure.

What is claimed is:

1. A developing cartridge, detachably installed on a drum cartridge in an image forming apparatus, wherein the drum cartridge is provided with a photosensitive drum, the image forming apparatus includes a separation force output member, and the developing cartridge includes:
a casing having a first side and a second side arranged opposite to each other along a first direction, a third side and a fourth side arranged opposite to each other along a second direction, and a fifth side and a sixth side arranged opposite to each other along a third direction, wherein the casing is installed in the drum cartridge in the second direction, and the first direction, the second direction and the third direction intersect each other;
a coupling rotatable about a coupling axis extending in the first direction, the coupling being positioned at the first side;
a developing roller rotatable about a developing axis extending in the first direction, the developing roller being positioned at the third side;
a storage medium including an electrical contact surface, the electrical contact surface facing the sixth side, and the electrical contact surface being positioned at the second side; and
a separator for receiving a separation force applied by the separation force output member that causes the casing to move, the separator including a first inclined surface wherein the separation force output member moves in the first direction and abuts against the first inclined surface, and the separator being positioned at the first side.

2. The developing cartridge according to claim 1, wherein the separator is fixedly arranged on the casing, an extending direction of the first inclined surface is inclined relative to the first direction, and the first inclined surface causes the casing to move.

3. The developing cartridge according to claim 2, wherein an extension line of a line connecting the coupling axis and the developing axis passes through the first inclined surface.

4. The developing cartridge according to claim 3, wherein a protective cover is provided at the first side, the protective cover protects the coupling, and the separator is integrally formed with the protective cover or fixedly installed on the protective cover.

5. The developing cartridge according to claim 4, wherein a starting end of the first inclined surface is further away from the sixth side than an ending end of the first inclined surface in the third direction, and the starting end of the first inclined surface is closer to the second side than the ending end of the first inclined surface in the first direction.

6. The developing cartridge according to claim 5, further comprising a contact part, wherein the contact part is positioned at the second side, and the first side swings away from a photoconductor drum with the contact part as a fulcrum.

7. The developing cartridge according to claim 3, further comprising a load-bearing part, wherein the load-bearing part is positioned at the first side and protrudes in first direction, the load-bearing part contacts the drum cartridge to support the developing cartridge, and the load-bearing part moves in the third direction with respect to the drum cartridge when the first inclined surface cause the first side to move.

8. The developing cartridge according to claim 7, wherein the load-bearing part is semi-cylindrical, the separator is integrally formed with the load-bearing part.

9. The developing cartridge according to claim 8, wherein the separator is further away from the developing roller than the load-bearing part in the second direction.

10. The developing cartridge according to claim 7, further comprising a forced pushing part, wherein the forced pushing part includes a pressure receiving surface for receiving a forced pushing force applied by the drum cartridge, the pressure receiving surface is flat, and the first inclined surface overcomes the forced pushing force and causes the first side to move.

11. The developing cartridge according to claim 10, wherein a distance from the forced pushing part to the developing roller is greater than a distance from the load-bearing part to the developing roller in the second direction.

12. The developing cartridge according to claim 2, wherein an angle between the first inclined surface and the first direction ranges from 38° to 58°.

13. The developing cartridge according to claim 12, wherein the angle between the first inclined surface and the first direction is 48°.

14. The developing cartridge according to claim 12, wherein the first inclined surface receives the separation force from the first direction and breaks the separation force into the third direction to move the first side in a direction away from the photosensitive drum.

15. The developing cartridge according to claim 1, further comprising a holder, wherein the holder holds the electrical contact surface, and the holder is fixedly mounted on the second side.

16. The developing cartridge according to claim 15, wherein the separator at least partially overlaps with the holder when viewed in the first direction.

17. The developing cartridge according to claim 1, further comprising an agitator, wherein the agitator receives a force transmitted by the coupling and rotates, and an axis of rotation of the agitator is located between the separator and the developing axis in the second direction.

18. The developing cartridge according to claim 1, wherein the separator is constrained not to move relative to the casing in the first direction.

19. The developing cartridge according to claim 18, wherein the separator is constrained not to move relative to the casing in the second direction and the third direction.
